(19) United States
(12) Patent Application Publication
(10) Pub. No.: US 2013/0318930 A1
(43) Pub. Date: Dec. 5, 2013

(54) Bottom-Discharging Scrap Bin and Dumping Method Thereof

(71) Applicants: Hongtao Deng, Shenzhen (CN); Tsungi Hung, Shenzhen (CN)

(72) Inventors: Hongtao Deng, Shenzhen (CN); Tsungi Hung, Shenzhen (CN)

(21) Appl. No.: 13/575,295

(22) PCT Filed: Jun. 5, 2012
(86) PCT No.: PCT/CN12/76454

§ 371 Date: Jul. 25, 2012

(30) Foreign Application Priority Data
May 30, 2012 (CN) 201210174118.7

(51) Int. Cl. B65F 1/14; B65B 69/00; B65F 1/02

(52) U.S. Cl. 53/492; 220/4.01

(57) ABSTRACT

The present invention relates to a bottom-discharging scrap bin and a dumping method thereof. The bottom-discharging scrap bin includes a bin body that has an upper end opening and a lower opening that is rotatably coupled to the bottom board by a door shaft to allow the bottom board to selectively close the lower end opening of the bin body. The lower end opening is fixable to the bottom board by a locking device. Handles are provided on the bin body for receiving forks of a fork lift to insert therein to lift the bin body. When the bin is full of scraps, the locking device is locked and the bottom board closes the lower end opening. To dump the scraps, the locking device is unlocked and the bottom board is rotated with respect to the lower end opening to be opened.

### BACKGROUND OF THE INVENTION

1. Field of the Invention

The present invention relates to the field of liquid crystal manufacturing techniques, and in particular to a bottom-discharging scrap bin and a dumping method thereof.

2. The Related Arts

High-generation liquid crystal panel manufacture processes often generate a great amount of glass scraps after a cutting step is carried out. For example, abnormal situations often occur in a sealant process, such as sealant extending across a cutting line, thereby making the scraps that are supposed to be separated still attaching to the glass panel and a portion that is supposed to keep being undesirably removed. Consequently, a scrap bin is used to receive and hold the glass scraps. In the manufacturing operations of a cell workshop, a known scrap bin that is conventionally used to receive and hold glass scraps is often made relatively large in size in order to meet the needs for capacity. When the scrap bin is full of the glass scraps, due to the size and weight of the bin being extremely large, it is not possible to use a fork lift to dump the scraps out of the bin.

As shown in FIG. 1, a conventional scrap bin that is provided for receiving and holding glass scraps is illustrated. The scrap bin 10 comprises four sidewalls 11. These sidewalls 11 surround a bottom board and are fixed to the bottom board to define a rectangular parallelepiped receiving space for receiving and holding glass scraps. The bottom board is supported on floor by support legs 12. Due to the needs of the known liquid crystal manufacture process, the scrap bin 10 is made in a relatively lager size and will have an extremely heavy weight after being filled with glass scraps. It becomes impossible to dump the scrap bin 10 in a normal way, either manually or with the aid of a fork lift. An improvisatory solution is using a fork lift to carry out one-side lifting, in which the fork lift conveys the scrap bin 10 to a designated site and then the fork lift is operated to lift one side of the scrap bin 10 so as to turn the scrap bin 10 up-side down to allow the glass scraps to be dumped out. This solution is disadvantageous in that the scrap bin 10 that is full of glass scraps is extremely heavy and may get easily damaged when being turned up-side down and may cause hazards to an operator staying nearby.

To eliminate the drawback of easily damaging the scrap bin in the known process of dumping, heretofore, the scrap bins are often made of SUS304 steel. For a cell workshop of a regular size, there are 18 scrap bins set up in the workshop and each cost RMB$30,000 for being made of SUS304 steel. There is potential risk of damaging the scrap bins if the known process is followed. Taking 30% production capacity as an example, there will be four scrap bins damaged for each half year. For manufacture with full production capacity, there will be a loss of 27 scrap bins for each year. For the current arrangement of 18 bins in a workshop, in a situation of manufacture of full production capacity, the scrap bins will all get broken down. Consequently, with the known way of dumping, there will be an expenditure of 27×RMB$30,000=RMB$810,000 for the broken scrap bins. Apparently, the conventional scrap bin and the known way of dumping scrap bins may easily damage the scrap bins, are of high cost, and require further improvement.

### SUMMARY OF THE INVENTION

Thus, an object of the present invention is to provide a bottom-discharging scrap bin that allows of dumping scraps with a fork lift and a dumping method thereof.

To achieve the object, the present invention provides a bottom-discharging scrap bin, which comprises a bin body, a bottom board, a door shaft, a locking device, and handles. The bin body has an upper end opening and a lower opening. The lower end opening of the bin body is rotatably coupled to the bottom board by the door shaft so that the bottom board is pivotally supported by the door shaft to selectively close the lower end opening of the bin body. The lower end opening of the bin body is fixable to the bottom board by the locking device. The handles are provided on the bin body for receiving forks of a fork lift to insert therein to lift the bin body, whereby when full of scraps, the locking device is locked and the bottom board closes the lower end opening of the bin body and to dump the scraps, the locking device is unlocked and the bottom board is rotated with respect to the lower end opening of the bin body through the door shaft and is thus opened.

Wherein, the bottom-discharging scrap bin further comprises stop plates, which are circumferentially arranged around the lower end opening of the bin body and extend upward from the bottom board.

Wherein, the handles respectively define a linear opening at two opposite sides of the upper end opening of the bin body.

Wherein, the bottom-discharging scrap bin further comprises an insertion slot for receiving insertion of forks of a fork lift. The insertion slot is formed on an undersurface of the bottom board.

Wherein, the bin body is a rectangular parallelepiped container that is circumferentially surrounded by four sidewalls.

Wherein, the door shaft is mounted to a first side of the lower end opening of the bin body.

Wherein, the locking device is mounted to a second side of the lower end opening of the bin body that is opposite to the first side.

The present invention also provides a dumping method of bottom-discharging scrap bin, which comprises the following steps:

Step 100: when the bottom-discharging scrap bin is full of scraps, a fork lift is operated to transport the bottom-discharging scrap bin to a designated site; and

Step 200: to dump, a locking device is first unlocked and the fork lift is operated to lift handles of the bottom-discharging scrap bin so as to allow the scraps to freely fall due to gravity.

Wherein, the bottom-discharging scrap bin comprises a bin body, a bottom board, a door shaft, a locking device, and handles, the bin body having an upper end opening and a lower opening, the lower end opening of the bin body being rotatably coupled to the bottom board by the door shaft so that the bottom board is pivotally supported by the door shaft to selectively close the lower end opening of the bin body, the lower end opening of the bin body being fixable to the bottom board by the locking device, the handles being provided on the bin body for receiving forks of a fork lift to insert therein to lift the bin body, whereby when full of scraps, the locking device is locked and the bottom board closes the lower end opening of the bin body and to dump the scraps, the locking device is unlocked and the bottom board is rotated with respect to the lower end opening of the bin body through the door shaft and is thus opened.

Wherein, the bottom-discharging scrap bin further comprises stop plates, which are circumferentially arranged around the lower end opening of the bin body and extend upward from the bottom board.

In summary, the present invention provides a bottom-discharging scrap bin, which allows of dumping scraps with a fork lift, so as to be safe, reliable, economic and durable. The present invention also provides a dumping method of bottom-discharging scrap bin that dumps scraps with a fork lift and is thus safe and reliable and the bottom-discharging scrap bin is economic and durable.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 shows a conventional scrap bin for receiving and holding glass scraps;

FIG. 2 is a perspective view showing a bottom-discharging scrap bin according to a preferred embodiment of the present invention;

FIG. 3 is another perspective view showing the bottom-discharging scrap bin according to the preferred embodiment of the present invention;

FIG. 4 is a perspective view showing a condition that the bottom-discharging scrap bin according to the preferred embodiment of the present invention dumps scraps;

FIG. 5 is a schematic view illustrating a transportation operation of a dumping method of the bottom-discharging scrap bin according to the present invention;

FIG. 6 is a schematic view illustrating a dumping operation of the dumping method of the bottom-discharging scarp bin according to the present invention; and

FIG. 7 is a flow chart illustrating the dumping method of the bottom-discharging scrap bin according to the present invention.

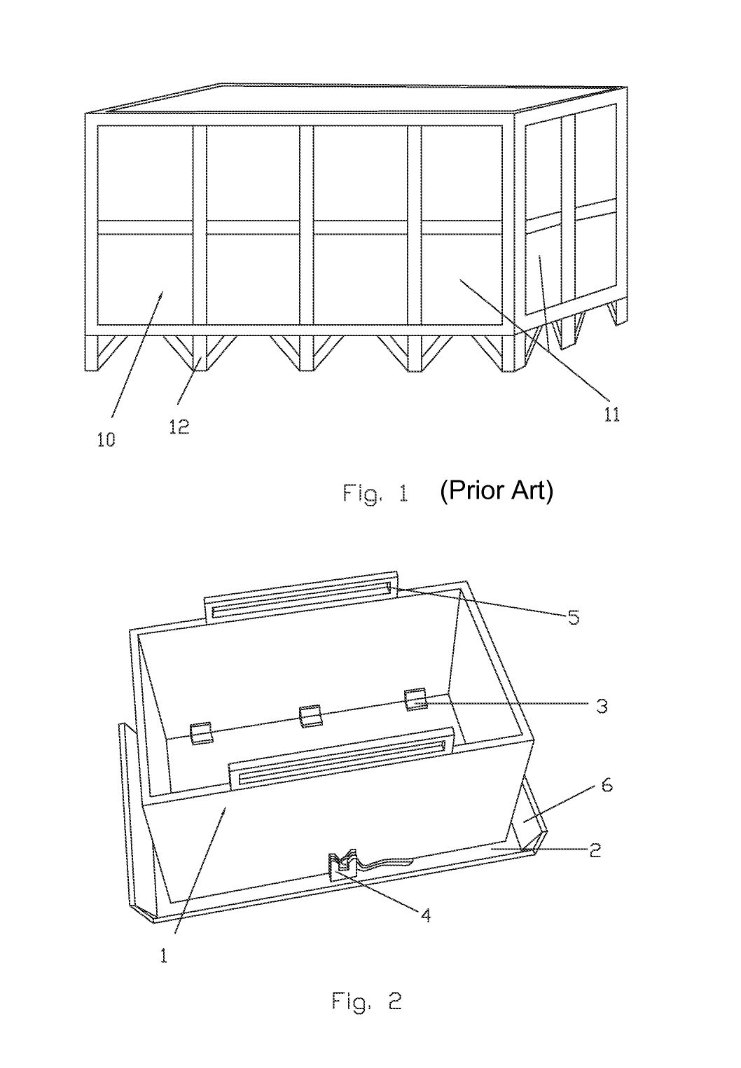

### DETAILED DESCRIPTION OF THE PREFERRED EMBODIMENTS

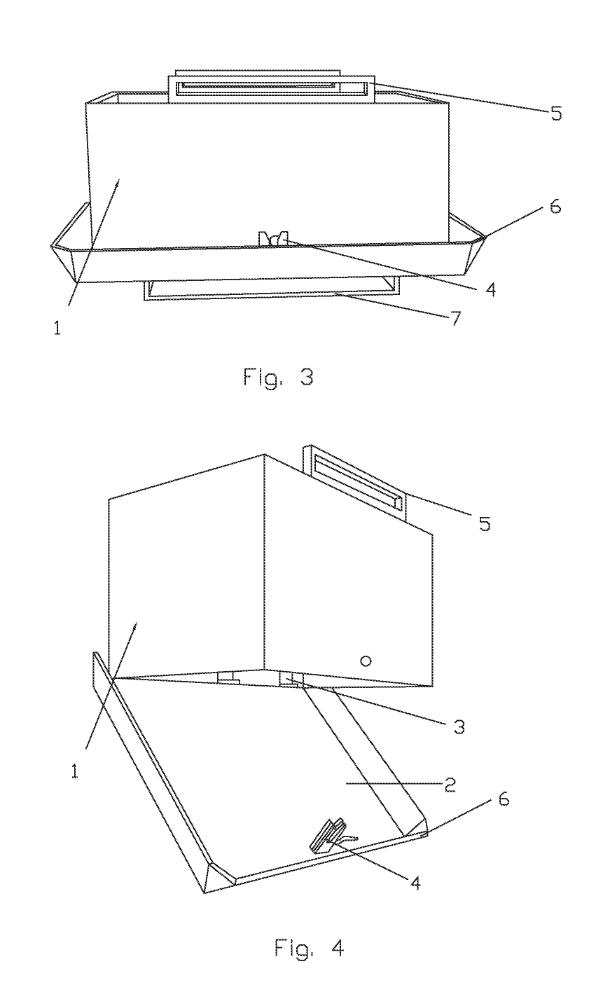

Referring to FIGS. 2-4, FIG. 2 is a perspective view showing a bottom-discharging scrap bin according to a preferred embodiment of the present invention, FIG. 3 is another perspective view of the preferred embodiment, and FIG. 4 is a perspective view showing a condition that the preferred embodiment is dumping scraps. The bottom-discharging scrap bin according to the present invention comprises a bin body 1, a bottom board 2, a door shaft 3, a locking device 4, and handles 5. The bin body 1 has an upper end opening and a lower opening. The upper end opening functions to collect scraps and the lower end opening functions to dump scraps. The handles 5 are provided on the bin body 1 to allow the forks of a fork lift to insert therein for lifting the bin body 1. The lower end opening of the bin body 1 is rotatably coupled to the bottom board 2 by the door shaft 3. The bottom board 2 is pivotally supported by the door shaft 3 to close the lower end opening of the bin body 1. The lower end opening of the bin body 1 is also fixable to the bottom board 2 by the locking device 4. A portion of the locking device 4 is mounted to the bin body 1, while the remaining portion is fixed to the bottom board 2, and the two portions are couplable through locking. In the preferred embodiment, the bin body 1 is a rectangular parallelepiped container that is circumferentially surrounded by four sidewalls. The door shaft 3 is mounted to one side of the lower end opening of the bin body 1, while the locking device 4 is mounted to the opposite side. The handles 5 are respectively mounted to two opposite sides of the upper end opening to respectively define a linear opening. When full of scraps, the locking device 4 is locked and the bottom board 2 covers and closes the lower end opening of the bin body 1. To dump the scraps, the locking device 4 is unlocked and the bottom board 2 is rotated with respect to the lower end opening of the bin body 1 through the door shaft 3 and is thus opened.

The bottom-discharging scrap bin of the preferred embodiment further comprises stop plates 6. The stop plates 6 are circumferentially arranged around the lower end opening of the bin body 1 and extend upward from the bottom board 2. An insertion slot 7 is provided for receiving the insertion of the forks of a fork lift. The insertion slot 7 is formed on an undersurface of the bottom board 2 to receive forks of a fork lift to insert therein for transportation. In the bottom-discharging scrap bin of the preferred embodiment, the four sides of the bottom of the bin is only coupled to the door shaft 3 by one side, and the remaining three sides are not fixed. With the arrangement of the locking device 4, securing can be realized with the locking device 4 during transportation so as to prevent outward scattering of glass scraps caused by vibration. In dumping, an operator may unlock the locking device 4. The arrangement of the side stop plates 6 helps preventing outward scattering of the scraps. To dump the scraps, the operator first unlock the locking device 4 and then opearates the fork lift to penetrate into the handles 5 and upward move. The weight of the glass scraps acts on the surfaces of the bin and the bottom board 2 and may automatically open with the rotation of the bottom board 2 about a door shaft axis of the door shaft 3 so as to allow the glass scraps to fall down naturally.

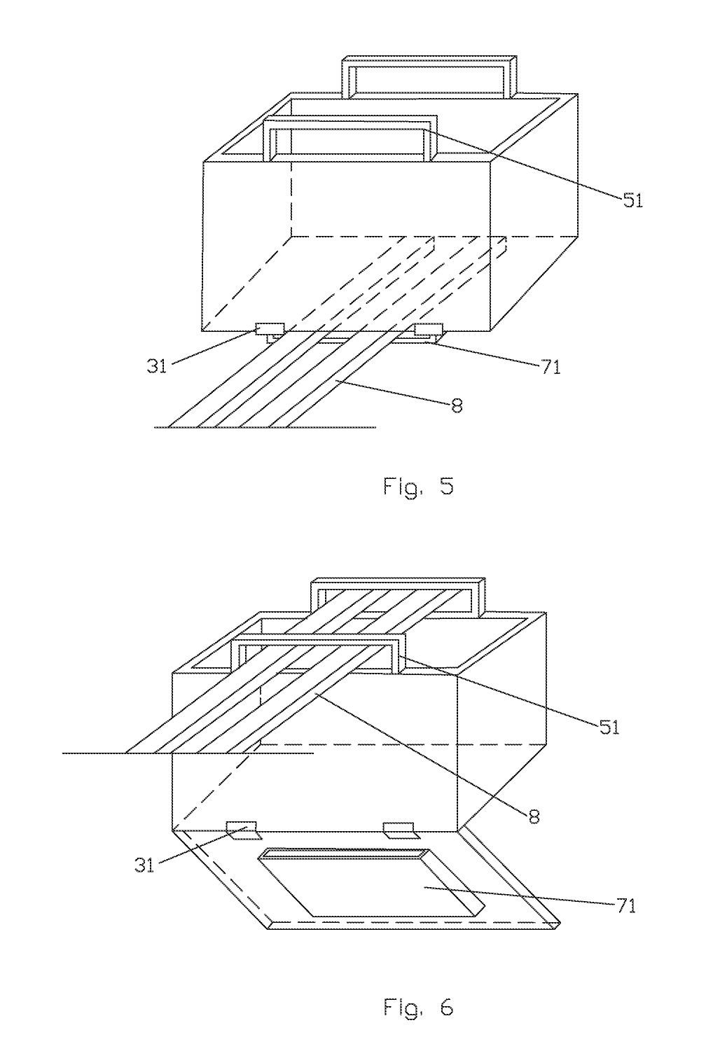

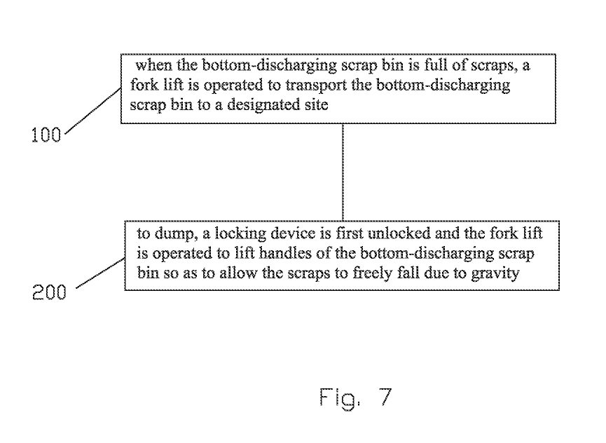

Referring to FIGS. 5-7, FIG. 5 is a schematic view illustrating a transportation operation of a dumping method of the bottom-discharging scrap bin according to the present invention, FIG. 6 is a schematic view illustrating a dumping operation of the dumping method of the bottom-discharging scarp bin according to the present invention, and FIG. 7 is a flow chart illustrating the dumping method of the bottom-discharging scrap bin according to the present invention. The dumping method of bottom-discharging scrap bin according to the present invention comprises the following steps:

Step 100: when the bottom-discharging scrap bin is full of scraps, a fork lift is operated to transport the bottom-discharging scrap bin to a designated site. As shown in FIG. 5, during the transportation, the scrap bin is full of broken pieces of glass. Forks 8 of the fork lift are insertable into the insertion slot 71 on the undersurface of the scrap bin in order to transport the scrap bin to the designated site.

Step 200: to dump, a locking device is first unlocked and the fork lift is operated to lift handles of the bottom-discharging scrap bin so as to allow the scraps to freely fall due to gravity. As shown in FIG. 6, to dump, an operator first unlocks the locking device and then operates the forks 8 of the fork lift to lift upward the handles 51 located on the top side. Since the bottom is only fixed at one side by a door shaft 31, the broken pieces of glass are allowed to freely fall by the gravity thereof.

The bottom-discharging scrap bin of the present invention is widely applicable to the LCD (Liquid Crystal Display) industry. After the use, a dumping operation can be carried out with a fork lift in order to protect safety of operators. Since the dumping method of bottom-discharging scrap bin according to the present invention does not easily damage the bin body, the scrap bin can be made of cast iron, making it cheap and durable. The cost is around RMB$8,000 for each bin. If 18 bins are purchased and are estimated to last for a period of 5 years, then the expenditure for the scrap bins is 18×RMB$8,000/5=RMB$28,800 each year. The reduction of cost is RMB$810,000−RMB$28,800=RMB$781,200 each year.

In summary, the present invention provides a bottom-discharging scrap bin, which allows of dumping scraps with a fork lift, so as to be safe, reliable, economic and durable. The present invention also provides a dumping method of bottom-discharging scrap bin that dumps scraps with a fork lift and is thus safe and reliable and the bottom-discharging scrap bin is economic and durable.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A bottom-discharging scrap bin, comprising a bin body, a bottom board, a door shaft, a locking device, and handles, the bin body having an upper end opening and a lower opening, the lower end opening of the bin body being rotatably coupled to the bottom board by the door shaft so that the bottom board is pivotally supported by the door shaft to selectively close the lower end opening of the bin body, the lower end opening of the bin body being fixable to the bottom board by the locking device, the handles being provided on the bin body for receiving forks of a fork lift to insert therein to lift the bin body, whereby when full of scraps, the locking device is locked and the bottom board closes the lower end opening of the bin body and to dump the scraps, the locking device is unlocked and the bottom board is rotated with respect to the lower end opening of the bin body through the door shaft and is thus opened.

2. The bottom-discharging scrap bin as claimed in claim 1 further comprising stop plates, which are circumferentially arranged around the lower end opening of the bin body and extend upward from the bottom board.

3. The bottom-discharging scrap bin as claimed in claim 1, wherein the handles respectively define a linear opening at two opposite sides of the upper end opening of the bin body.

4. The bottom-discharging scrap bin as claimed in claim 1 further comprising an insertion slot for receiving insertion of forks of a fork lift, the insertion slot being formed on an undersurface of the bottom board.

5. The bottom-discharging scrap bin as claimed in claim 1, wherein the bin body is a rectangular parallelepiped container that is circumferentially surrounded by four sidewalls.

6. The bottom-discharging scrap bin as claimed in claim 5 wherein the door shaft is mounted to a first side of the lower end opening of the bin body.

7. The bottom-discharging scrap bin as claimed in claim 6, wherein the locking device is mounted to a second side of the lower end opening of the bin body that is opposite to the first side.

8. A bottom-discharging scrap bin, comprising a bin body, a bottom board, a door shaft, a locking device, and handles, the bin body having an upper end opening and a lower opening, the lower end opening of the bin body being rotatably coupled to the bottom board by the door shaft so that the bottom board is pivotally supported by the door shaft to selectively close the lower end opening of the bin body, the lower end opening of the bin body being fixable to the bottom board by the locking device, the handles being provided on the bin body for receiving forks of a fork lift to insert therein to lift the bin body, whereby when full of scraps, the locking device is locked and the bottom board closes the lower end opening of the bin body and to dump the scraps, the locking device is unlocked and the bottom board is rotated with respect to the lower end opening of the bin body through the door shaft and is thus opened;
stop plates being provided to be circumferentially arranged around the lower end opening of the bin body and extending upward from the bottom board;
wherein the handles respectively define a linear opening at two opposite sides of the upper end opening of the bin body;
an insertion slot being provided for receiving insertion of forks of a fork lift, the insertion slot being formed on an undersurface of the bottom board;
wherein the bin body is a rectangular parallelepiped container that is circumferentially surrounded by four sidewalls;
wherein the door shaft is mounted to a first side of the lower end opening of the bin body; and
wherein the locking device is mounted to a second side of the lower end opening of the bin body that is opposite to the first side.

9. A dumping method of a bottom-discharging scrap bin, comprising the following steps:
(1) when the bottom-discharging scrap bin is full of scraps, a fork lift is operated to transport the bottom-discharging scrap bin to a designated site; and
(2) to dump, a locking device is first unlocked and the fork lift is operated to lift handles of the bottom-discharging scrap bin so as to allow the scraps to freely fall due to gravity.

10. The dumping method of a bottom-discharging scrap bin as claimed in claim 9, wherein the bottom-discharging scrap bin comprises a bin body, a bottom board, a door shaft, a locking device, and handles, the bin body having an upper end opening and a lower opening, the lower end opening of the bin body being rotatably coupled to the bottom board by the door shaft so that the bottom board is pivotally supported by the door shaft to selectively close the lower end opening of the bin body, the lower end opening of the bin body being fixable to the bottom board by the locking device, the handles being provided on the bin body for receiving forks of a fork lift to insert therein to lift the bin body, whereby when full of scraps, the locking device is locked and the bottom board closes the lower end opening of the bin body and to dump the scraps, the locking device is unlocked and the bottom board is rotated with respect to the lower end opening of the bin body through the door shaft and is thus opened.

11. The dumping method of a bottom-discharging scrap bin as claimed in claim 10, wherein the bottom-discharging scrap bin further comprises stop plates, which are circumferentially arranged around the lower end opening of the bin body and extend upward from the bottom board.
